(19) United States
(12) Patent Application Publication
(10) Pub. No.: US 2008/0035537 A1
(43) Pub. Date: Feb. 14, 2008

(54) Fuel filter system

(75) Inventors: Gunnar-Marcel Klein, Spiegelberg (DE); Guenter Jokschas, Murrhardt (DE); Martin Klein, Stuttgart (DE)

Correspondence Address: CROWELL & MORING LLP;INTELLECTUAL PROPERTY GROUP, P.O. BOX 14300, WASHINGTON, DC, 20044-4300, US

(73) Assignee: Mann & Hummel GmbH, Ludwigsburg (DE)

(21) Appl. No.: 11/889,048

(22) Filed: Aug. 8, 2007

Related U.S. Application Data
(63) Continuation of application No. PCT/EP06/50647, filed on Feb. 3, 2006.

(30) Foreign Application Priority Data
Feb. 8, 2005 (DE) 10 2005 005 848.5

(51) Int. Cl. B01D 35/02; B01D 35/16; B01D 35/18; B01D 36/00

(52) U.S. Cl. 210/94; 210/183; 210/248; 210/260; 210/85

(57) ABSTRACT

A fuel filter system characterized by a simple design provided with a coalescer element (20) disposed in the immediate fuel inlet region for improving the elimination of water droplets. The coalescer element includes an upper end plate (26) that extends to the inner wall of the housing (10), thereby sealing the coalescer element as well as the inlet region and the outer unfiltered fluid region. The coalescer element (20) and the particle filter (19) are arranged on a common separating element (25), which rests against the discharge tube (17) located in the center of the fuel filter via a profiled seal. The end plate of the coalescer element can be produced with the profiled elastomeric seal molded thereon by two-component injection molding or by overmolding.

### CROSS REFERENCE TO RELATED APPLICATIONS

This application is a continuation of international patent application no. PCT/EP2006/050647, filed Feb. 3, 2006 designating the United States of America, and published in German on Aug. 17, 2006 as WO 2006/084823, the entire disclosure of which is incorporated herein by reference. Priority is claimed based on Federal Republic of Germany patent application no. DE 10 2005 005 848.5, filed Feb. 8, 2005.

### BACKGROUND OF THE INVENTION

The present invention relates to a fuel filter system suitable for a liquid fuel such as diesel fuel, in which a particle filter is provided inside a housing.

U.S. Pat. No. 5,084,170 discloses a fuel filter which has a housing enclosing a primary filter element and a secondary filter element. Fuel flows through the primary filter element from the inside to the outside. The primary filter element also has coalescing properties, so that any water that may be present in the fuel coalesces, i.e., larger water droplets form. These droplets pass into a water collection sump. To prevent the water droplets from flowing through the second filter element, the filter element is provided with hydrophobic materials, particularly silicone, so that an outer water barrier is formed. Both the primary filter element and the secondary filter element are formed of a pleated filter paper or a nonwoven filter web. Whereas the fuel flows through the primary filter element from the inside to the outside, it flows through the secondary filter element from the outside to the inside, and the filtered fuel is supplied to the filtered fluid line through a tube. A disadvantage of this construction is that the primary filter element becomes loaded with dirt because of its filtering properties, and this dirt reduces or prevents flow through the filter. Furthermore, the primary filter element loses its coalescing properties over time, which means that the filter system as a whole loses its water separation properties, or water separation becomes progressively less effective until the filter element is replaced.

### SUMMARY OF THE INVENTION

It is therefore an object of the invention to provide an improved fuel filter system.

Another object of the invention is to provide a fuel filter system which ensures highly effective water separation over the entire service life of the filter element.

A further object of the invention is to provide a fuel filter system which can be manufactured in a simple and cost effective manner.

These and other objects are achieved in accordance with the present invention by providing a fuel filter system comprising a filter housing, a particle filter disposed inside the housing, and a coalescer element for improving separation of water contained in unfiltered fuel by the particle filter, said coalescer element being arranged upstream of the particle filter such that fuel to be filtered flows first through the coalescer element and then through the particle filter, wherein the coalescer element has an end plate or seal plate for providing a seal between the upstream fuel and the downstream fuel, said plate being formed as a single piece and extending radially across the coalescer element to a wall of the housing.

An advantage of the invention is that the coalescer element has a simple structure, and particularly the seal plate or end plate necessary for sealing is formed as a single piece and extends to a wall of the housing. This eliminates the need for an additional sealing element.

In a further refinement of the invention, the seal plate or end plate is formed of a two-component synthetic resin material, such that the first component is a conventional thermoplastic synthetic resin material and the second component an elastomer. The second component carries out the sealing function along the wall of the housing. In place of a two-component seal plate, it is also possible to use a seal ring or a molded seal. This seal ring or molded seal is arranged in the radially outer region of the end plate and is in any case located outside the effective coalescer area.

In another embodiment of the invention the fluid inlet opening provided on the housing and the fluid inlet opening on the end plate of the coalescer are substantially registered or aligned so that the fluid does not change direction as it flows into the coalescer. This has the advantage that if water droplets have already formed in the fuel, they will not be broken apart by baffle edges or baffle surfaces.

In yet another embodiment of the seal for the coalescer element, this seal is an axial seal, i.e., a profiled seal or molded seal situated on the end plate facing toward the inlet opening.

In principle, both the coalescer element and the filter element are fixed in position by a spring washer, which is supported against the bottom of the housing and applies an axial force to the filter element. At the one end of the filter element this spring element serves for both radial guidance and axial positioning. At the opposite end, that is to say in the region of the fuel inlet opening, radial positioning is effected via a discharge nipple or tube or corresponding mounting members formed on the discharge tube.

In yet another embodiment of the invention, a water collection sump having an opening or a drain valve for discharging the water is arranged at the bottom of the housing. A heater and/or water sensor also may be provided in this region. The water collection sump itself is integrated into the housing. It is also possible, however, to screw a vessel that is made, for example, of a transparent synthetic resin material to a housing which is open at the bottom.

The coalescer element is preferably made of a hydrophobic material. The downstream particle filter can also have an outer layer of a hydrophobic material, e.g., a fabric, a meltblown web or a nonwoven web.

These and other features of preferred embodiments of the invention, in addition to being set forth in the claims, are also disclosed in the specification and/or the drawings, and the individual features each may be implemented in embodiments of the invention either alone or in the form of subcombinations of two or more features and can be applied to other fields of use and may constitute advantageous, separately protectable constructions for which protection is also claimed.

### BRIEF DESCRIPTION OF THE DRAWINGS

The invention will be described in further detail hereinafter with reference to illustrative preferred embodiments shown in the accompanying drawing figures, in which:

FIG. 1 is a cutaway schematic view of a fuel filter according to the invention;

FIG. 2 is an enlarged detail view of the inlet region of a fuel filter according to the invention, and

FIGS. 3 to 6 show variants of the inlet region of the fuel filter of FIG. 1.

### DETAILED DESCRIPTION OF PREFERRED EMBODIMENTS

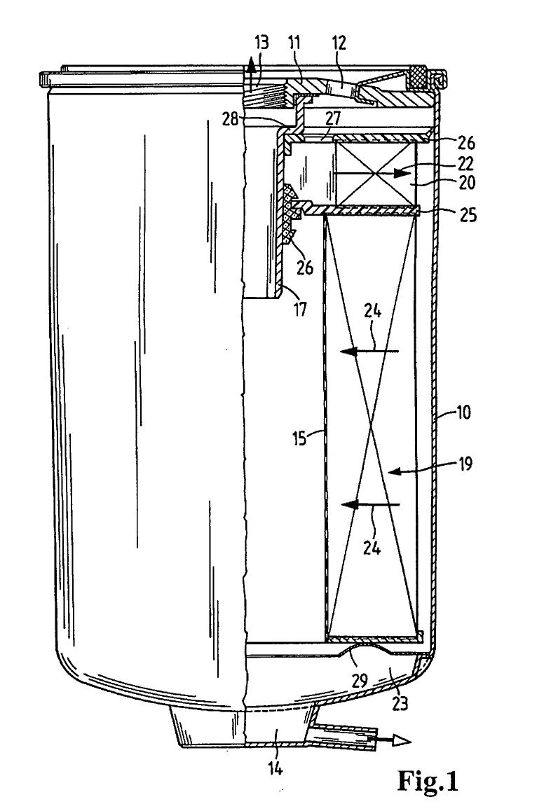

A fuel filter according to the invention as shown in FIG. 1 has a housing 10 which is a substantially cylindrical vessel. The top of housing 10 is closed by a cover 11. Cover 11 has inlet openings 12 for the fuel to flow in. One of these openings is shown in the figure. These inlet openings are configured as bores and are uniformly distributed around a partial circle. Furthermore, an outlet opening 13 is provided, from which the filtered fuel can be discharged. At the lower end of the housing 10 is a water discharge valve 14, which is indicated only schematically in the figure. A discharge tube 17 is located within the housing.

Inside the housing 10 is a particle filter 19 that is formed of a pleated filter material which may be constructed of a plurality of layers. A coalescer element 20 is arranged upstream of the particle filter 19. In the illustrated embodiment, this coalescer element is also formed of a pleated medium. This medium can be a polyester material, a polyamide or some other material with water coalescing properties.

The particle filter 19 has a support tube 15 along its inner wall, which is provided with openings so that the filtered fluid can pass through unhindered into the central region before flowing out through the discharge tube 17.

The medium being filtered, such as diesel fuel, flows in through the inlet opening 12 and through the coalescer element 20 from the inside to the outside, as indicated by arrow 22. The water in the fuel coalesces to large or larger agglomerations or droplets, then flows downwardly along the housing wall 10 and collects in a water reservoir 23. The fuel being filtered flows through the filter element from the outside to the inside as indicated by arrow 24, is filtered there and exits the filter system through the discharge tube 17 and the outlet opening 13. When water has collected in the water reservoir 23 up to a certain level, the water can be removed through the water discharge valve 14.

Between the coalescer element 20 and the particle filter 19 is a separating element 25, which is secured to the outer wall of the discharge tube 17 by a profiled seal 26 and ensures a fluid-tight separation of the upstream inlet region from the downstream filtered fluid region. The particle filter 19 and the coalescer element 20 are bonded or welded to or embedded in the separating element 25. Like the cover 11, the upper end plate 26 of the coalescer element has concentrically distributed inlet openings 27 and in its outer region has a seal relative to the wall of the housing 10. This end plate 26 thus constitutes a seal plate, which is preferably formed as a single piece. This end plate 26 simultaneously acts as a limit stop for the elements 20 and 19. The limit stop is defined by an inwardly directed shoulder 28 on the discharge tube 17. Because of the upward force applied by a spring element 29, which rests against the housing 10 and applies an axial force to the particle filter 19, the depicted elements 19 and 20 are fixed in the position shown. The spring element 29 simultaneously serves to compensate any longitudinal tolerances of the housing or the elements located therein.

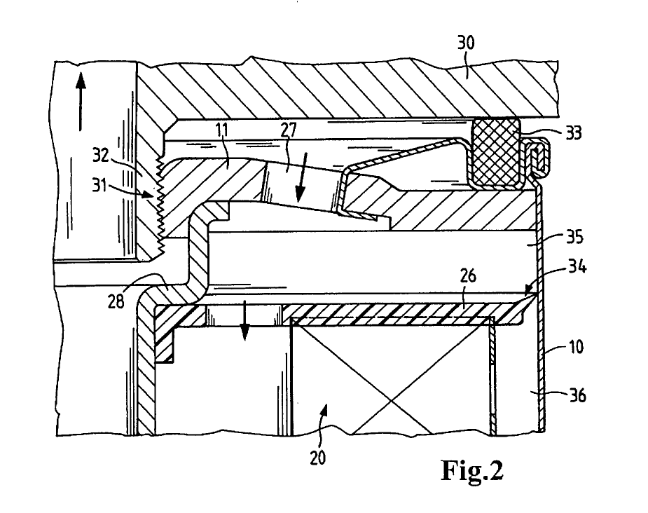

FIG. 2 is a detail view of the upstream inlet region for the fuel being filtered. Parts identical to those of FIG. 1 are identified by the same reference numerals.

The filter system is screwed to a mounting structure 30 via a thread 31 formed on the cover 11 and a threaded nipple 32 disposed on the mounting structure. The unfiltered fluid region is sealed off by a profiled seal 33. The end plate or seal plate 26 is formed of a thermoplastic synthetic resin material, the outer region of which is tapered toward the housing 10 and is configured like a lip 34. The soft-elastic structure of this lip 34 ensures a seal between the upstream fluid region 35 and the downstream fluid region 36. The shape of the lip makes it possible to compensate any tolerances of the housing 10 or any minor out-of-roundness.

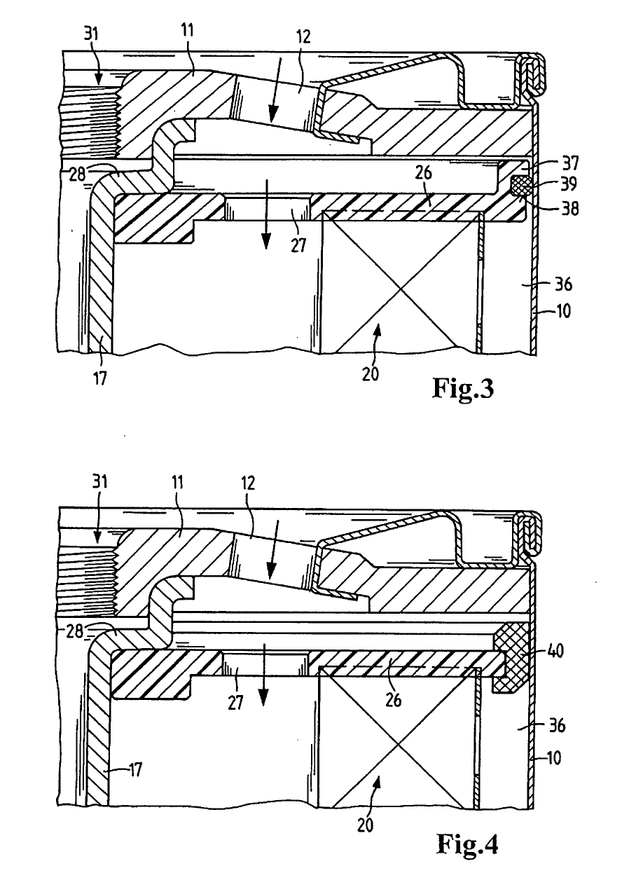

FIG. 3 shows a seal plate 26 having a receiving groove 38 formed by an upwardly extending collar 37. An O-ring 39 or some other kind of resilient seal can be inserted into this receiving groove.

To prevent a redirection of the flow of the fluid fed through the cover inlet opening 12, the end plate 26 has inlet openings 27 that are approximately aligned with the cover inlet openings 12. This prevents the fluid from having to be redirected or diverted around edges. This reduced flow redirection prevents the water droplets in the fluid from being broken up because of flow around edges or because of turbulence and therefore increases the efficiency of the coalescer.

FIG. 4 illustrates another sealing principle for the end plate 26. In this case the end plate, which has a smaller diameter than the inside diameter of the housing 10, has a profiled seal 40 in the shape of a U-profile. This seal is pulled or placed over the end plate prior to assembly and provides a particularly reliable seal because of the relatively large sealing length. Because the lower leg of the U-profile seal does not extend into the region of the filter element, it does not restrict the effective filter area in any way, that is, the fluid can flow out of the coalescer element all the way to the end plate. Thus it can be seen that the seal system is located outside the effective coalescer area.

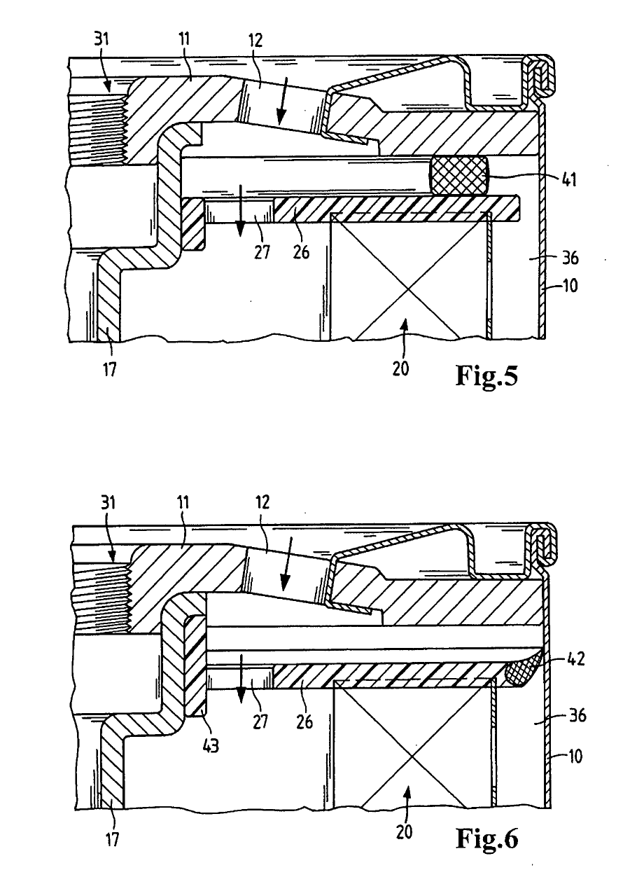

FIG. 5 shows an axial seal 41, which is placed onto or bonded to the end plate 26. This seal is a simple profile seal with a square shape and also serves to define the axial position of the coalescer element and the particle filter 19. An axial stop such as shown in FIG. 1 on the discharge tube 17 is not necessary in this case.

FIG. 6 shows an end plate 26 with a two-component structure. The inner region of the end plate is formed of a synthetic resin material, such as polyamide, for example. An elastomer lip 42 is injection molded onto the outer edge thereof. This elastomer lip fits against the housing 10 so as to form a seal. The coalescer element and the particle filter 19 are axially supported by webs 43 arranged on the end plate 26.

The foregoing description and examples have been set forth merely to illustrate the invention and are not intended to be limiting. Since modifications of the described embodiments incorporating the spirit and substance of the invention may occur to persons skilled in the art, the invention should be construed broadly to include all variations within the scope of the appended claims and equivalents thereof.

What is claimed is:

1. A fuel filter system comprising a filter housing, a particle filter disposed inside the housing, and a coalescer element for improving separation of water contained in unfiltered fuel by the particle filter, said coalescer element being arranged upstream of the particle filter such that fuel to be filtered flows first through the coalescer element and then through the particle filter, wherein the coalescer element has an end plate for providing a seal between upstream fuel and downstream fuel, said plate being formed as a single piece and extending radially across the coalescer element to a wall of the housing.

2. A filter system according to claim 1, wherein the end plate is formed of a two-component synthetic resin material, the first component comprising a thermoplastic synthetic resin and the second component comprising an elastomer.

3. A filter system according to claim 2, wherein said thermoplastic synthetic resin is a polyester or polyamide.

4. A filter system according to claim 1, wherein the end plate is provided with a seal system located outside the effective coalescer area, said seal system comprising a seal ring or a molded seal.

5. A filter system according to claim 1, wherein the housing has at least one inlet opening for fuel to be filtered, and said inlet opening is aligned with an opening in the end plate of the coalescer such that fuel to be filtered flows into the coalescer essentially without being redirected.

6. A filter system according to claim 1, wherein the seal between the coalescer element and the housing is an axial seal.

7. A filter system according to claim 1, wherein a water collection sump is arranged in a lower region of the housing and is equipped with a water drain valve.

8. A filter system according to claim 7, further comprising a heater in said water collection sump.

9. A filter system according to claim 7, further comprising a water sensor arranged in said water collection sump for controlling operation of the water drain valve.

10. A filter system according to claim 1, wherein the coalescer element is formed of a hydrophobic material and the particle filter has a hydrophobic outer layer.

11. A filter system according to claim 10, wherein said hydrophobic outer layer is a fabric, a meltblown web or a nonwoven web.

12. A filter system according to claim 7, wherein the water collection sump is formed of a transparent synthetic resin material.
